(19) United States
(12) Patent Application Publication
(10) Pub. No.: US 2011/0262346 A1
(43) Pub. Date: Oct. 27, 2011

(54) REACTORS AND METHODS FOR PRODUCING SPIN ENRICHED HYDROGEN GAS

(75) Inventors: Rachel KATZ-BRULL, Modi'in-Maccabim-Re'ut (IL); Moshe GOMORI, Jerusalem (IL); Claudia M. BARZILAY, Reut (IL); Ayelet GAMLIEL, Jerusalem (IL)

(73) Assignee: HADASIT MEDICAL RESEARCH SERVICES & DEVELOPMENT LIMITED, Jerusalem (IL)

(21) Appl. No.: 13/086,642

(22) Filed: Apr. 14, 2011

Related U.S. Application Data
(60) Provisional application No. 61/324,593, filed on Apr. 15, 2010.

(51) Int. Cl. C01B 3/02; C01B 3/08

(52) U.S. Cl. 423/648.1; 423/657; 422/600

(57) ABSTRACT

The present invention provides a reactor and a process for producing spin enriched hydrogen and/or deuterium gas.

### FIELD OF THE INVENTION

This invention relates to reactors and methods for producing spin enriched hydrogen gas.

### BACKGROUND OF THE INVENTION

The parahydrogen induced polarization (PHIP) methodology has been studied since the early 1980s¹⁻⁶ and gained renewed interest following the application of this concept for producing contrast on in vivo magnetic resonance imaging (MRI)⁷⁻¹⁰. Particularly attractive is the ability to transfer the increased spin order of the parahydrogen molecule to a neighboring nucleus such as carbon-13 or nitrogen-15 and create, in effect, multinuclear “hyperpolarized” molecular probes. Upon administration of such hyperpolarized molecular probes to the circulation, “background free” images can be obtained using in vivo multinuclear imaging^{7,9}. A parallel approach for obtaining such background free images, and specifically spectroscopic images, is the dynamic nuclear polarization (DNP) approach. The main advantage of this methodology is its ability to create the hyperpolarized state in many types of molecular sub-structures. However, the main disadvantage of this technology is the costly DNP apparatus and maintenance, combined with the long time (more than 30 min) of a single sample preparation. The main advantages of the PHIP methodology are its possible low-tech setup and the quick preparation of the hyperpolarized sample (few seconds). The latter offers a major advantage for dynamic biological studies and especially to in vivo studies.

The ability of the PHIP methodology to achieve enhancement of NMR signals of two to four orders of magnitude for in vitro and in vivo applications has been well documented^{7,8,9,10}. The performance of the parallel approach, the orthodeuterium induced polarization (ODIP) has been demonstrated in vitro. Despite this wealth of information, the main challenge in implementing this technology is the practical setup of a PHIP or ODIP apparatus for cost efficient and reproducible studies.

The following references are considered pertinent for describing the state of the art in the field of the invention:
1. Bowers, C. R.; Weitekamp, D. P., Transformation of symmetrization order to nuclear-spin magnetization by chemical reaction and nuclear magnetic resonance. Phys. Rev. Lett. 1986, 57, (21), 2645-2648.
2. Bowers, C. R.; Weitekamp, D. P., Parahydrogen and synthesis allow dramatically enhanced nuclear alignment. J. Am. Chem. Soc. 1987, 109, (18), 5541-5542.
3. Eisenschmid, T. C.; Kirss, R. U.; Deutsch, P. P.; Hommeltoft, S. I.; Eisenberg, R.; Bargon, J.; Lawler, R. G.; Balch, A. L., Para hydrogen induced polarization in hydrogenation reactions. J. Am. Chem. Soc. 1987, 109, (26), 8089-8091.
4. Natterer, J.; Bargon, J., Parahydrogen induced polarization. Prog. Nucl. Magn. Reson. Spectros. 1997, 31, 239-315.
5. Jonischkeit, T.; Woelk, K., Hydrogen induced polarization-nuclear-spin hyperpolarization in catalytic hydrogenation without the enrichment of para or orthohdrogen. Adv. Synth. Catal. 2004, 346, 960-969.
6. Duckett, S. B.; Sleigh, C. J., Applications of the parahydrogen phenomenon: A chemical perspective Prog. Nucl. Magn. Reson. Spectros. 1999, 34, (1), 71-92.
7. Golman, K.; Axelsson, O.; Jóhannesson, H.; Månsson, S.; Olofsson, C.; Petersson, J. S., Parahydrogen-induced polarization in imaging: subsecond ¹³C angiography. Magn. Reson. Med. 2001, 46, (1), 1-5.
8. Hövener, J.-B.; Chekmenev, E. Y.; Harris, K. C.; Perman, W. H.; Tran, T. T.; Ross, B. D.; Bhattacharya, P., Quality assurance of PASADENA hyperpolarization for ¹³C biomolecules. Magn. Reson. Mater. Phys., Biol. Med. 2009, 22, (2), 123-134.
9. Natterer, J.; Greve, T.; Bargon, J., Orthodeuterium induced polarization. Chem. Phys. Lett. 1998, 293, 455-460.
10. Bargon, J.; Limbacher, A.; Rizi, R. R., Orthodeuterium induced ¹H- and ²D-Hyperpolarization for MRI. Proc. Intl. Soc. Mag. Reson. Med. 2006, 14, 3111.
11. Oskar, A.; Haukur, J. Ex vivo nuclear polarisation of a magnetic resonance imaging contrast agent by means of ortho-deuterium enriched hydrogen gas. EP 1058122 A2, 2000.
12. Goldman, M.; Jóhannesson, H.; Axelsson, 0.; Karlsson, M., Design and implementation of ¹³C hyper polarization from para-hydrogen, for new MRI contrast agents. C. R. Chim. 2006, 9 357-363.
13. Andrewsa, L.; Wang, X., Simple ortho-para hydrogen and para-ortho deuterium converter for matrix isolation spectroscopy. Rev. Sci. Instrum. 2004, 75, (9), 3039-3044.

### SUMMARY OF THE INVENTION

In the first aspect of the invention there is provided a reactor for producing spin enriched hydrogen gas, comprising:
a first compartment (i.e. a hydrogen gas generating unit) comprising at least two reagents capable of producing hydrogen gas;
a second compartment (i.e. a spin enriching unit) comprising at least one hydrogen spin converting catalyst; wherein at least a part of said second compartment containing said catalyst is being contained in an external cooling chamber to maintain catalyst containing part of said second compartment under temperatures enabling spin enriching of said hydrogen gas, and at least another part of said second compartment is maintained at room temperature (i.e. above the external cooling chamber);
said first and second compartments being connected such that hydrogen gas produced in first compartment transfers into said second compartment; and
second compartment having an outlet for discharging spin enriched hydrogen gas produced.

In the context of the present invention the first compartment allows for the in situ production of hydrogen or deuterium gas in metered safe amounts capable of being controlled by the quantitative amount of reagents used. It is noted that any reaction capable of producing hydrogen or deuterium gas may be employed using the reactor of the present invention, thus using at least two different reagents capable of producing either hydrogen or deuterium gas. In some embodiments both reagents capable of producing hydrogen gas are placed simultaneously in said first compartment. In other embodiments the at least two reagents are placed in said first compartment consecutively. In some embodiments a first reagent is placed in said first compartment thereby connecting said compartment to a second reagent feeding unit, capable of transferring said second reagent to first compartment comprising first reagent, thereby initiating hydrogen production reaction.

In some embodiments, said at least two reagents capable of producing hydrogen gas are selected from H₂O, D₂O, NaAlO₂ NaBH₄, NaBD₄, Al, Al/Na₂SnO₃ or any combinations thereof.

In some embodiments a first reagent capable of producing hydrogen is meant to encompass any reagent which upon reaction with water, D₂O, acids or bases (which may be isotopically labeled) under typical processing conditions produces hydrogen gas. In some embodiments, said first reagent capable of producing hydrogen gas is selected from acids, bases, metal and metal alloys such as for example NaAlO₂ NaBH₄, NaBD₄, Al, Al/Na₂SnO₃. In some preferred embodiments said first reagent is a solid none-hazardous reagent. In other embodiments said first reagent is NaBH₄ or NaBD₄.

In other embodiments said second reagent of said at least two reagents capable of producing hydrogen gas is selected from water, D₂O, acids or bases (which may be isotopically labeled). Said second reagent is matched to said first reagent for the production of hydrogen or deuterium gas. In the case where at least one of said at least two reagents capable of producing hydrogen gas is in the liquid state, said reagent is capable of being delivered to first compartment via a feeding unit connected to said first compartment. As used herein the term “liquid feeding unit” relates to a unit capable of transferring said liquid reagent to said first compartment. Said feeding unit is connected to first compartment through appropriate tubing system. Said unit may have metering means for measuring exact amount of water transferred to first compartment.

As used herein the term “hydrogen spin converting catalyst” is meant to encompass any catalyst capable of enriching the spin ratio of thus produced hydrogen or deuterium gas.

Molecular hydrogen (H₂) comprises two nuclear spin isomers, parahydrogen with opposed nuclear spins and orthohydrogen with parallel nuclear spins. At T>298 K the equilibrium proportions are 25:75 para:ortho respectively, and this mixture is referred to as “Normal Hydrogen”. Below 298 K the equilibrium ratio of the para hydrogen increases. For example at liquid nitrogen temperature (77K) an equilibrium ratio of 52:48 is expected.

For the deuterium molecule (D₂), the orthodeuterium spin isomer is dominant The fraction of orthodeuterium is ca. 67% at room temperature and increases to 70% and ca. 98% at 77 K and 20 K, respectively. In order to reach a mixture that is significantly enriched with the orthodeuterium spin isomer and demonstrate the ODIP effect, a low temperature (T<65 K) is needed. The apparatus of the present invention may be used for both PHIP and ODIP studies.

In other embodiments, said at least one hydrogen spin converting catalyst is selected from iron oxide, activated carbon or any combination thereof. It is noted that other hydrogen spin converting catalysts known to a person skilled in the art may be employed by a reactor of the invention.

When referring to said at least a part of said second compartment containing said catalyst being contained in a cooling chamber to maintain catalyst containing part of said second compartment under temperatures enabling spin enriching of said hydrogen gas, it should be understood that said part of said second compartment may be placed in an external cooling chamber, not in direct connection with the contents of said second compartment, while the other part of said second compartment is maintained at room temperature. The temperature of said cooled part of second compartment being maintained in said cooling chamber is such that enables the para:ortho spin ratio of hydrogen gas to be enriched with the para spin hydrogen. When deuterium gas is produced the para:ortho spin ratio is enriched with the ortho spin deuterium gas in said cooled part of second compartment. In some embodiments the ratio between at least a part of said second compartment containing said catalyst being cooled in an external cooling chamber and between at least other part of said second compartment maintained at room temperature is selected from 1:1, 0.5:1, 1:0.5, 0.25:1, 1:0.25.

In further embodiments, said external cooling chamber contains liquid nitrogen. In other embodiments, said external cooling chamber contains liquid helium. In further embodiments said cooling chamber provides a temperature of at least about <65 K by crycooling.

When referring to said first and second compartments being connected such that hydrogen gas produced in first compartment transfers into said second compartment, it should be understood to encompass any type of tubing enabling the diffusing and/or flow of hydrogen gas produced from first to second compartment. In some embodiments said reactor is being held under vacuum prior to hydrogen production.

In some embodiments said connection of first and second compartments further comprises at least one drying tube.

In further embodiments, said discharge outlet in second compartment is connected to a product receiving compartment.

In some other embodiments, said second compartment is made of transparent material. The transparency of said second compartment enables the user to position the hydrogen spin converting catalyst contained therein at the desired part of said second compartment, i.e. in the part being maintained under temperatures enabling spin enriching of said hydrogen gas (e.g. cooled with an external cooling chamber). The exclusive location of said catalyst in said desired temperature is important since some of the spin conversion catalysts (for example iron oxide) can catalyze spin conversion of hydrogen gas from ortho to para (at low temperatures) but also the reverse conversion from para to ortho (at room temperature). In case said catalyst is located at the part of said second compartment being maintained under room temperature, some of the para-enriched hydrogen gas will quickly convert back to the ortho state and the overall efficiency of the system will decrease.

In further embodiments, said second compartment is made of low thermal conductivity material. Low thermal conductivity material provides the two parts of said second compartment, i.e. the part being maintained under temperatures enabling spin enriching of said hydrogen gas (e.g. cooled with an external cooling chamber) and the part being maintained at room temperature to be distinct, with minimal overlapping temperature zone wherein the temperature is intermediate. In some other embodiments said second compartment is made of glass. The choice of a “glass-trap” was made due to two reasons: first, because the glass is transparent, the exact location of the catalyst is readily controllable. The second reason for using the “glass trap” is the low thermal conductivity of the glass. It is expected that the heat exchange from the surrounding to the liquid nitrogen through the glass is much lower than the heat exchange that occurs when metal compartments (for example copper tubes) are being used.

Without being bound by theory it is noted that the “glass trap” used in said second compartment, wherein hydrogen spin enrichment is performed enables free passage or diffusion of hydrogen or deuterium gas thus produced in said first compartment, between two temperature zones: a liquid nitrogen temperature zone (or a catalyzing temperature zone, where the catalyst is placed and the hydrogen gas undergoes spin conversion) and room temperature zone (where the gas is found in a state amenable for withdrawal from the apparatus). The hydrogen that underwent spin conversion in the cold catalyzing zone does not undergo a reverse spin conversion at room temperature because the catalyst is located exclusively in the cold catalyzing zone and the spin transition in the absence of a catalyst is a forbidden one. It is further noted that at liquid nitrogen temperature, the hydrogen gas is found at a condensed state where withdrawal using a syringe or any other and manual force is hindered.

In a further aspect the invention provides a method of producing spin enriched hydrogen gas comprising:
providing at least one first reagent capable of producing hydrogen gas in a first compartment;
reacting said at least one first reagent with at least one second reagent in first compartment to produce hydrogen gas;
transferring thus produced hydrogen gas to a second compartment comprising at least one hydrogen spin converting catalyst;
subjecting said second compartment to conditions for the production of spin enriched hydrogen gas.

In some embodiments of a method of the invention, said at least one first reagent capable of producing hydrogen gas is selected from NaAlO₂ NaBH₄, NaBD₄, Al, Al/Na₂SnO₃ or any combinations thereof. In a further embodiment of a method of the invention, said at least one second reagent is selected from H₂O, D₂O, HCl, DCl, NaOH, NaOD or any combinations thereof.

When referring to “conditions for the production of spin enriched hydrogen gas” it should be understood to encompass the performance of said spin enrichment in second compartment wherein the part containing catalyst is maintained under temperatures enabling spin enriching of said hydrogen gas. Therefore, in some embodiments said conditions for the production of spin enriched hydrogen gas comprise: maintaining at least a part of said second compartment comprising at least one hydrogen spin converting catalyst in a temperature allowing spin enrichment of hydrogen gas produced in first compartment and maintaining second part of said second chamber at room temperature. In some embodiments of a method of the invention said conditions allowing the production of spin enriched hydrogen gas comprise subjecting said second compartment to temperatures of between about 77 K to 17 K. In other embodiments of a method of the invention said second chamber is maintained in said temperature for about 10 minutes to about 5 hours or continuously in the case of closed circle cooling device or cryocooling device.

In other embodiments of a method of the invention said produced hydrogen gas is dehydrated prior to transfer to second compartment. In other embodiments of a method of the invention, said produced spin enriched hydrogen gas is dehydrated.

In some embodiments a reactor of the invention is composed of the following components: 1) a hydrogen gas source unit (for either H₂ or D₂); 2) a spin conversion unit; 3) a hydrogen injection unit; and 4) a hydrogenation reactor including solvent(s), hydrogenation catalyst, and reactants.

A reactor of the invention provides the following advantages: local small scale in situ production of hydrogen or deuterium in safe amounts, avoiding the risk of explosion; minimization of heat exchange within the spin conversion chamber; complete immersion of the spin conversion catalyst in the cooling liquid, to avoid back conversion at room temperature; and immediate use of the spin converted hydrogen.

A reactor of the invention is a compact, cost-efficient, and meets safety requirements for the in situ generation of small amounts of hydrogen (either H₂ and D₂). The polarization levels reached using hydrogen obtained by the use of a reactor of the invention were at the higher end of the performance as compared with known techniques in the art. The system provides a source of para-hydrogen for biomedical PHIP studies in a hospital MRI suite environment.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an illustration of a reactor of the invention for the production of isotopically and spin enriched hydrogen for induced polarization studies. A—hydrogen production unit; B—the a spin conversion unit; and C—a sealed plastic bag ensuring atmospheric pressure.

FIGS. 2A-2B shows an orthohydrogen signal in “Normal hydrogen” (FIG. 2A) and para-enriched hydrogen mixture (FIG. 2B).

FIG. 3 shows hydrogen and deuterium gas production reactions (I-II), and hydrogenation reactions employing p-H₂ or D₂ (III-VI).

FIGS. 4A-4B shows typical orthodeuterium signal on D spectra of D_{2 (g)} at 77 K (A) and at room temperature (B).

FIGS. 5A-5C shows PHIP ¹H spectra of ethyl propiolate hydrogenation reaction. FIG. 5A shows ALTADENA spectrum, single transient recorded c.a. 15 sec after the para-enriched hydrogen injection (minimal gain). FIG. 5B shows PASADENA spectrum, single transient recorded immediately at the end of enriched hydrogen injection (minimal gain). FIG. 5C shows a reference spectrum recorded after decay of the hyperpolarized signal in FIG. 5A. This spectrum is enlarged 22 fold in comparison to FIG. 5A as evident by comparison of the intensity of the substrate signal at ca. 1.25 ppm in both spectra.

FIGS. 6A-6B shows ¹³C-ALTADENA-NMR with field cycling. A single transient was recorded at high gain. B) ¹³C-NMR the same sample as in A after the decay of the hyperpolarized signal recorded with the same acquisition protocol and parameters. In addition, a relaxation delay of about 1 min was provided to allow the solvent peek to reach maximum intensity. *—acetone signals, EA—hyperpolarized ethyl acrylate signals.

FIGS. 7A-7C shows the PHIP ¹H spectra of ethyl phenyl propiolate hydrogenation reaction. FIG. 7A shows ALTADENA spectrum, single transient recorded c.a. 15 sec after the para-enriched hydrogen injection (minimal gain). FIG. 7B shows PASADENA spectrum, single transient recorded immediately at the end of enriched hydrogen injection (minimal gain). FIG. 7C shows a reference spectrum recorded before the hydrogenation reactions.

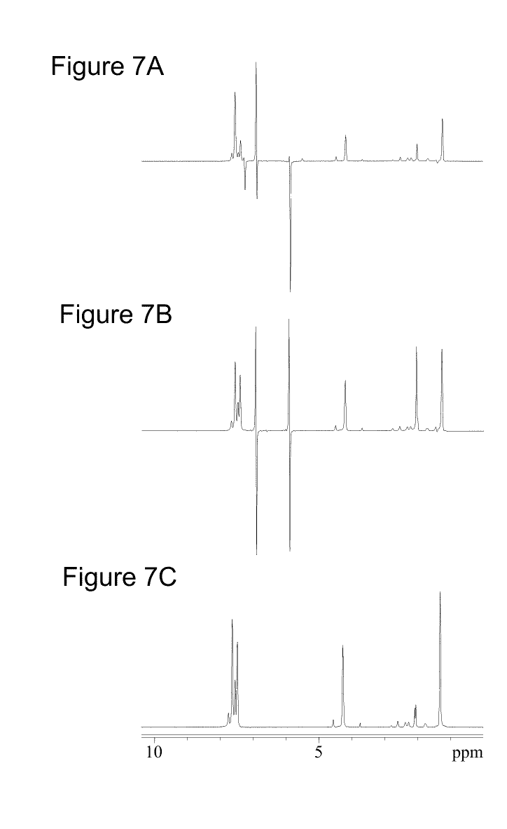

FIGS. 8A-8G shows the PHIP effects that do not originate from the hydrogenation product. FIG. 8A shows the ¹H-NMR spectrum of the hydrogenation product ethyl acrylate, after 10 injections of 5 ml H₂, recorded using 128 transients at high receiver gain to optimally detect the small product signals. FIG. 9B shows the ²H-NMR spectrum of the hydrogenation product after 22 injections of 5 ml D₂, recorded using 128 transients. FIG. 8C shows the ALTADENA study on the catalyst (cod)(dppb)Rh(I). FIG. 8D shows the PASADENA study on the catalyst (cod)(dppb)Rh(I). FIG. 8E is a reference spectrum, the catalyst in acetone prior to p-H₂ injections. FIG. 8F shows the ALTADENA spectrum enlarged to demonstrate the hyperpolarized signal of the catalyst and further reduction of ethyl acrylate to ethyl propionate. The reaction mixture contains ethyl propiolate and catalyst in acetone. FIG. 8G is a reference ¹H spectrum of ethyl propiolate and catalyst in acetone prior to p-H₂ injection. *—Acetone signal, m—water in acetone, s—substrate (ethylpropiolate), c—catalyst., EA—ethyl acrylate

FIG. 9 shows a typical T₂ measurement of a para-enriched mixture. T₂ measurements were performed with the Carr-Purcell-Meiboom-Gill pulse sequence. *—signal originating from the NMR tube. Varian parameters: At =50 ms, d1=5 ms, nt=320, sw=20,000 Hz

FIG. 10 shows a typical example of a T₁ measurement of hydrogen gas. T₁ measurements were performed with the Inversion Recovery pulse sequence using 320 transients per inversion delay and a relaxation delay of 55 msec. *—signal originating from the NMR tube.

### DETAILED DESCRIPTION OF EMBODIMENTS

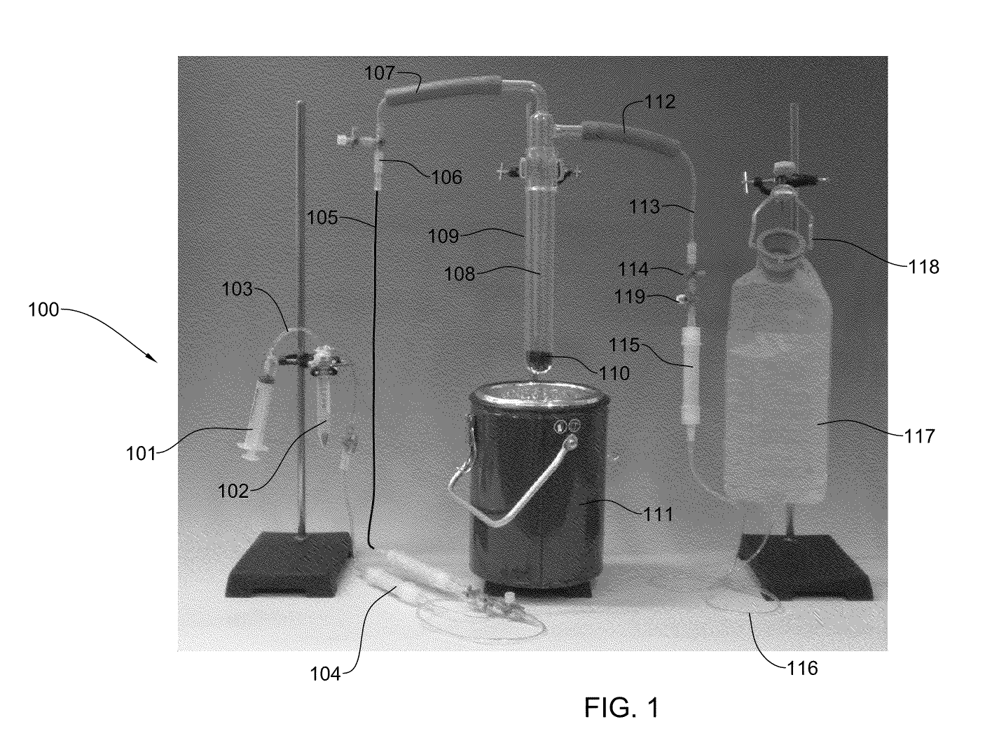

One embodiment of an assembled PHIP/ODIP reactor of the invention is shown in FIG. 1. This reactor (100) contains three main parts: 1) a part that produces the hydrogen gas—the hydrogen production unit (including elements 101,102, 103,104, 105); 2) a spin conversion unit which converts orthohydrogen to parahydrogen as well as paradeuterium to orthodeuterium (including elements 107, 108, 109, 110, 111, 112. 113, 114, 115); and 3) a unit that ensures hydrogen production at atmospheric pressure (including elements 116, 117, 118, 119).

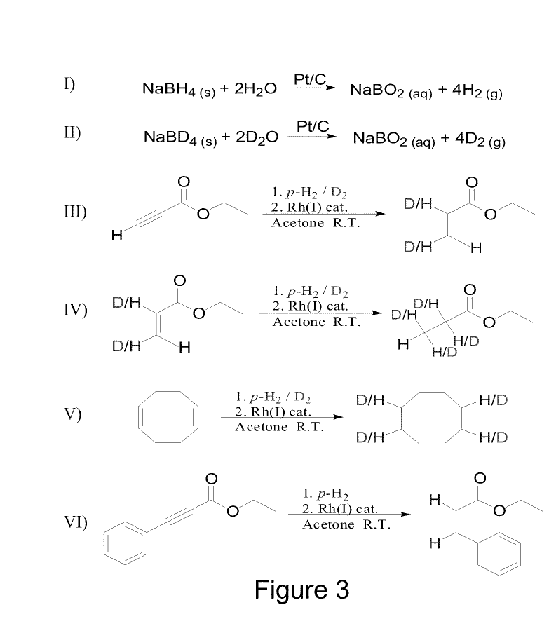

Production of hydrogen: Hydrogen (H₂) or deuterium (D₂) is produced by a chemical reaction of sodium borohydride or sodium borodeuteride, respectively, with water or deuterated water (D₂O), respectively, in the presence of platinum on carbon catalyst, as described in FIG. 3, schemes I and II, respectively. These reactions take place in the hydrogen production unit. Sodium borohydride and sodium borodeuteride are both solid compounds which allows for safe storage. Both are available in a powder form that allow quick production of small predetermined amounts of hydrogen (H₂) and deuterium (D₂). The hydrogen production reaction is started under vacuum. This is important in several aspects: 1) to ensure that the gas accumulating in the system is exclusively hydrogen and therefore to perform subsequent hydrogenation reactions efficiently in terms of the purity level of the hydrogen used; 2) to avoid the presence of oxygen in the system in order to avoid the risk of explosion/flammability of the hydrogen production unit; and 3) to diminish the possibility of reducing the level of spin enrichment by interaction with oxygen or another air component. The production of hydrogen gas is initiated by injecting a measured amount of water or D₂O from syringe 101 (through pipe 103) to a tube holding the solid reagents of the reaction (sodium borohydride or sodium borodeuteride and catalyst platinum on carbon) 102.

Hydrogen collection at atmospheric pressure: The hydrogen gas that is produced by this reaction flows through drying tubes (104) into (through connecting tube 105) the spin conversion part of a reactor of the invention (comprising outlet valve 106, inner tube of spin conversion compartment 108, outer cylinder of spin conversion unit 109, bottom of spin conversion compartment with catalyst 110, connecting tubes 112, 113, outlet valve 114, drying tube 115), which is inactive at room temperature, and is collected in a flexible sealed plastic bag (the collection bag 117) that serves as a unit that ensures hydrogen production at atmospheric pressure. Collection bag 117 is a flexible unit, its volume is null under vacuum (start of the hydrogen production reaction), and it expands when hydrogen is produced. Upon activation of spin conversion unity the volume of bag 117 decreases. When sufficient amount of hydrogen has accumulated in the collection bag, extra hydrogen that might continue to be produced in the unit is routed to another collection bag connected to outlet valve 119 (other bag not shown).

Spin conversion finger: The spin conversion occurs in a glass trap (108, 109, 110). The dimensions of this glass trap are as follows: external cylinder: height 220 mm, diameter 42 mm; inner tube: length 170 mm, diameter 10 mm. The glass-trap contains iron (III) oxide catalyst at its bottom 110 (about 25 g). Prior to the beginning of the spin conversion, the unit or compartment is sealed away from the spin conversion finger by the valve 106. Then the spin conversion finger is immersed in an external cooling chamber comprising liquid nitrogen 111. This is done by lowering the glass trap into the cooling chamber (Dewar) down to a level were the catalyst is about 10 cm below the liquid nitrogen level, leaving the remaining part of the glass trap 108 and 109 at room temperature. This immersion in liquid nitrogen results in a quick decrease in the gas volume. This is visible as a substantial decrease in the volume of the flexible bag 117. The hydrogen gas accumulates at the bottom of the cold finger next to the iron oxide catalyst 110. To isolate the hydrogen undergoing spin conversion from hydrogen that may remain in the collection bag, the passage between the two compartments is blocked by the valves 114 and/or 119.

Utilization of the enriched hydrogen: The enriched hydrogen is taken out of the spin conversion finger via outlet valve 114 and used immediately. The spin conversion of ortho to para hydrogen is expected to be time dependent. However, this dependency is intimately related to the catalyst surface area available to the hydrogen molecules and the total amount of hydrogen undergoing conversion. Here, the level of spin conversion was quantified at ca. 2 and 4 hours in liquid nitrogen and reached approximately 46% parahydrogen at 4 hours (as described in the results). However, significant PHIP effects were obtained already after 1 h in liquid nitrogen.

### Non-Limiting Examples

The NMR properties of the hydrogen mixtures produced by a reactor of the invention were characterized using the visible spin isomer of H₂, namely orthohydrogen. The ability to produce parahydrogen induced polarization effects was investigated in in situ alkyne hydrogenations.

Materials

Sodium borohydride, sodium borodeuteride, platinum 1 wt % on activated carbon (1% Pt/C), ethyl propiolate, ethyl phenylpropiolate, acetone-d6, and (1,5-cyclooctadiene) 1,4-bis(diphenylphospino)butane rhdium(I)teterafluoroborate: Rh(COD)(dppb) BF₄ were purchased from Sigma-Aldrich (Rehovot, Israel).

NMR Measurements

NMR measurements were carried out at 11.8 T (Varian Inc., Palo Alto, Calif.). Proton spectra were acquired either with direct or indirect detection 5 mm probes, ²H and ¹³C spectra were acquired with a direct detection probe.

Hydrogen and Deuterium Production

Sodium borohydride or sodium borodeuteride (0.7 g) and 1% Pt/C (150 mg) were placed in a 15 ml plastic tube and combined with 3 ml of purified water under vacuum (see Apparatus section). Under these conditions, about 600 ml of hydrogen or deuterium were produced within 20 min.

Gas Phase Studies

Prior to the gas-phase NMR measurements, the NMR tubes (5 mm, Wilmad, N.J., USA) were thoroughly washed with 3% HCl, then washed with purified water containing 30 mM EDTA, and then dried. Hydrogen was injected in excess into the NMR tube in an inverted position at atmospheric pressure using a long NMR pipette (Wilmad, N.J., USA). The tube was then sealed with a PTFE NMR tube caps (Sigma-Aldrich, Rehovot, Israel), and immediately transferred in an inverted position to the NMR spectrometer, where it was quickly turned to an upright position and immediately measured.

H₂ Spin Enrichment

¹H-NMR spectra were recorded using 320 averages, 55 ms relaxation delay, and a 90 degree flip angle. The enrichment of the hydrogen mixture with the para spin isomer was determined by comparing the intensities of the visible orthohydrogen signal (signal height multiplied by the full width at half height). Normal Hydrogen (see above) and enriched mixtures were sampled prior to and during the time that the spin conversion finger was immersed in liquid nitrogen, respectively.

T₁ and T₂ Measurements of H₂ Mixtures

T₁ measurements of H₂ mixtures were performed with the standard Inversion Recovery pulse sequence using 320 averages per inversion delay and a relaxation delay of 55 ms. T₂ measurements of H₂ mixtures were performed with the Carr-Purcell-Meiboom-Gill pulse sequence. Calculation of T₁ and T₂ was performed using the curve fitting tool in Matlab (The Mathworks Inc., Natick, Mass.).

Isotopic Enrichment, ²H-NMR

D₂ spectra were acquired using 1024 averages, 90 degree flip angle, and 60 ms relaxation delay.

PHIP Studies

Hydrogen was injected into a 5 mm NMR tube containing the reaction mixture, via PEEK tubes (O.D. 1.6 mm, I.D. 1 mm, Upchurch Scientific, WA, USA) through rubber septa (Wilmad, N.J., USA). The rate of the injection was 5 ml over 5 s. A small (ca. 1 mm) opening at the top of the NMR tube allowed gas outflow and ambient pressure conditions. For ALTADENA experiments, the reaction was carried out inside a magnetic shield (two concentric tubes, 10 cm and 15 cm in diameter, 50 cm long, Mu-Metal, The MuShield Company, NH, USA) and the hyperpolarized ¹H spectrum was recorded about 15 s after the injection (one transient at minimal receiver gain). Performing the hydrogenation reaction inside the shield ensured zero interference of the spectrometer's fringe field that could lead to mixed ALTADENA and PASADENA effects. For PASADENA experiments, the same reaction using the same hydrogen injection system and conditions was performed inside the spectrometer, and the spectrum was recorded immediately after the end of the hydrogen injection (one transient, minimal gain). Both PASADENA and ALTADENA PHIP studies were carried out using 45° pulses as previously described⁵.

The enhancement factor was calculated by comparing the integration of the PHIP signal to the product signal after relaxation (via comparison of both to the substrate signal). Both signals were compared on the basis of their SNR in a single scan following a single hydrogenation (injection of 5 ml H₂ at ambient pressure). However, because the thermal equilibrium signal of the ethyl acrylate that is produced following a single hydrogenation is small and close to the detection threshold, the intensity of this signal was calculated using a spectrum showing the product of 10 hydrogenations with 128 transients and optimal gain.

For ¹³C hyperpolarization studies, the enhanced spin order of the H₂ molecule was transferred to ¹³C at natural abundance by means of magnetic field changes, similar to previously described magnetic field cycling^{5,7,9,12}. In fact, the hydrogenation reaction and timing for both proton and carbon-13 ALTADENA studies was the same. Specifically, the hydrogenation reaction was performed at low magnetic field (of the order of nT) which was achieved using the Mu-Metal shield. Within 15 seconds, the sample was taken out of the magnetic shield, moved through the fringe field of the magnet, and placed in the 11.8 T spectrometer. A single ¹³C spectrum was recorded immediately. The full intensity solvent signals were used as an internal standard for concentration and enhancement factor calculation. These were acquired after the hyperpolarization decay using a long relaxation delay (>20 s) prior to the acquisition.

Reaction Conditions

Ethylpropoiolate hydrogenation (FIG. 3, scheme III): the reaction mixture contained ethyl propiolate (214 mM in 700 μL acetone-d6) and the rhodium catalyst (COD)(DPPB)Rh(I) BF₄ (10 mg, 20 mM). Similar conditions were described by Jonischkeit et al.⁵

Ethyl phenylpropiolate hydrogenation (FIG. 3, scheme VI): the reaction mixture contained ethyl phenylpropiolate (216 mM in 700 μL acetone-d6) and the rhodium catalyst (COD)(DPPB)Rh(I) BF₄ (13 mg, 25 mM). Similar conditions were described by Jonischkeit et al.²¹

Results

Parahydrogen Enrichment

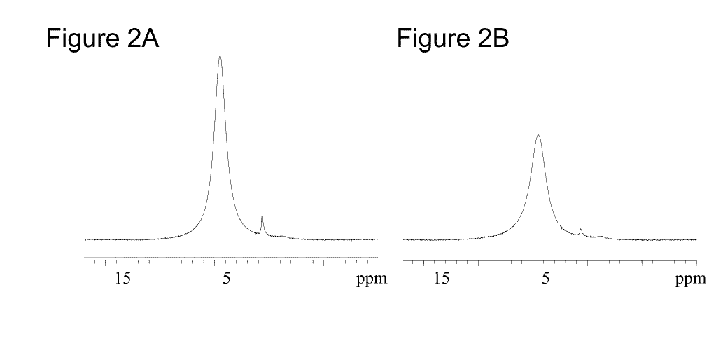

The effect of hydrogen mixture enrichment with the para spin isomer can be seen in FIGS. 2A-2B. Since only the ortho spin isomer is NMR visible, the signal of the para-enriched mixture is of lower area (ca. 1.33:1 area ratio non-enriched:enriched). This area ratio was converted to % enrichment taking into account the natural distribution at room temperature, in which 25% of the hydrogen in the mixture consists of the para spin isomer. The level of para-enrichment reached 42.3±0.4% (n=4) following 127±9 min in liquid nitrogen. This level had increased with the time of spin conversion (in liquid nitrogen), reaching 46.3±1.3% (n=4, P=0.0045, paired, two-tail, t-test) after 221±11 min. These values include data collected on three different experimental days. It is noted that this increase was not linear with the time in liquid nitrogen. The theoretical occupancy of the para spin isomer at liquid nitrogen temperature is 52%, therefore the expected orthohydrogen signal ratio at room temperature equilibrium and at 77 K equilibrium is 1.56:1. Without being bound by theory it is predicted that given a longer immersion periods in liquid nitrogen, this equilibrium value can be attained.

Hydrogen Mixtures Relaxation Times

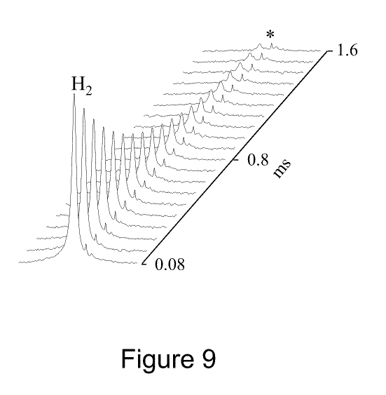

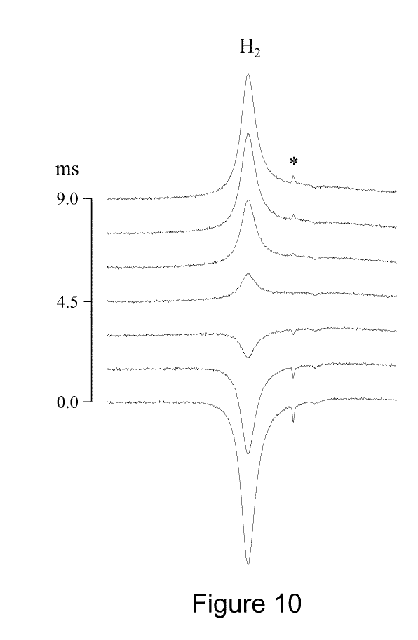

Interestingly, the line-width of the orthohydrogen signal in the para-enriched mixtures was wider than that of the “normal hydrogen” (840±44 Hz, n=15, and 629±14 Hz, n=9, respectively, P=2×10⁻¹², two-tail, t-test). For this reason, the T₂ of the hydrogen mixtures was investigated. A typical Carr-Purcell-Meiboom-Gill experiment is shown in FIGS. 9 and 10. Indeed, the T₂ of the para-enriched mixture was found to be shorter than that of the “normal hydrogen” (0.47±0.03 ms, n=3, and 0.54±0.01 ms, n=3, respectively, P=0.015, two-tail, t-test). However, this decrease did not fully explain the increase in the line-width of the signal. According to the measured T₂s, the expected line-widths are 680±50 Hz and 590±10 Hz, for the para-enriched and the “normal” hydrogen, respectively. The difference between the expected line-width according to the T₂ measurement and the actual line-width is larger for the para-enriched mixture.

The T₁ of the hydrogen mixtures was investigated as well. It was found that this relaxation time was not affected by the enrichment with the para spin isomer. A typical inversion recovery experiment is shown in FIGS. 9 and 10. The T₁ measured here for hydrogen mixtures at room temperature and ambient pressure was 3.7±0.9 ms, n=14. Previously, the T₁ of orthohydrogen in gas phase was determined at low temperatures (34 to 40 K), at varying pressures (up to 40 atm), and at high levels of parahydrogen enrichment of 86% to 99.4%. The T₁ of orthohydrogen in these conditions, at the low pressure values, was similar to the T₁ determined here, of the order of a few milliseconds¹³.

Hydrogen Gas Sample Stability

The described gas phase reactions were carried out immediately upon withdrawal of the gas sample from the apparatus. However, to test the stability of these samples in the NMR tube, fully relaxed spectra of the hydrogen mixtures were recorded for up to 20 minutes from the time of withdrawal. The level of ortho-hydrogen was found to be constant during this period. Therefore, it is not likely that any of the above measurements are affected by sample instability over the time frame of the measurement.

D₂ Production

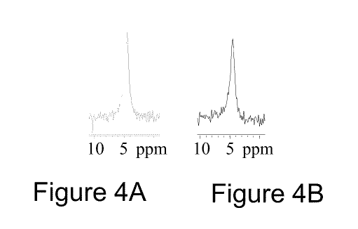

By exchanging sodium borohydride and H₂O for sodium borodeuteride and D₂O, the same apparatus was used for the production of deuterium (D₂) (see FIG. 3, scheme II). Typical ²H spectra of D₂ prior to and after 1.5 hours in liquid nitrogen are shown in FIG. 4. As opposed to the H₂ mixture, where at liquid nitrogen the mixture reaches a significant excess of parahydrogen above the “normal hydrogen”, the D₂ mixture is expected to reach only a small excess of orthodeuterium under the same conditions (70% vs. 67% at 77 K and room temperature, respectively)⁹. Therefore, as expected, the difference in the D₂ signal area in the mixtures that underwent spin conversion in liquid nitrogen and the mixtures at room temperature equilibrium was too low to be significantly measured: the signal area of the respective D₂ mixtures was the same (2127±97, n=3 and 2167±110, n=3, normalized arbitrary units).

PHIP Performance

The performance of the para-enriched hydrogen described above in PHIP reactions was investigated using the alkyne in situ hydrogenation reactions described above. Specifically the ethyl propiolate reaction was repeated numerous times to quantify and determine the reproducibility of the ATADENA and PASADENA effects.

Hydrogenation of Ethyl Propiolate

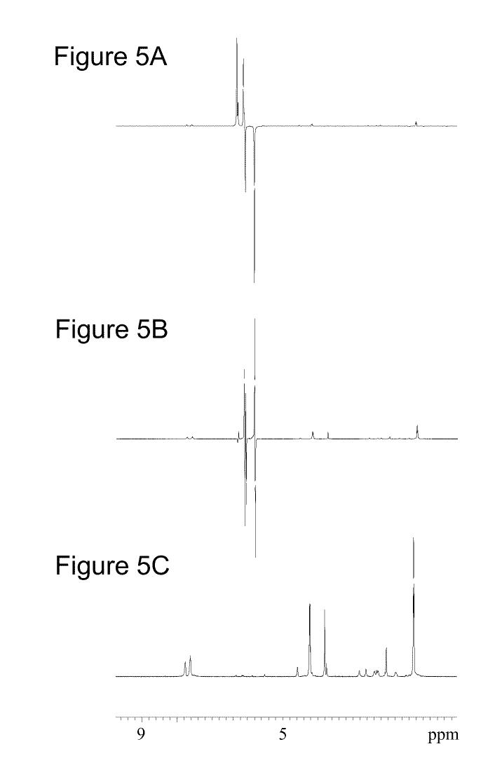

The in situ hydrogenation of ethyl propiolate to ethyl acrylate with the aid of a rhodium catalyst is described in FIG. 3, scheme III. The ALTADENA and PASADENA PHIP spectra of this reaction are shown in FIG. 5. The averaged ethyl acrylate concentration per injection of 5 ml p-H₂ (para-enriched hydrogen) was 1.75 mM and the reaction yield was about 1% (Table 1). The ALTADENA spectrum (FIG. 5A) demonstrates large signals of the hyperpolarized product at 5.85 ppm and 6.15 ppm. The third vinylic hydrogen at 6.3 ppm is also enhanced, as previously described²². The spectrum in FIG. 5C was recorded after the decay of the hyperpolarized signal. The product signal at thermal equilibrium level is visible. The intensity of both the ALTADENA and PASADENA (FIG. 5B) hyperpolarized signals were expressed in concentration values, from which the average values of the enhancement factors were calculated (ca. 3,000 and 1,000 respectively, Table 1).

TABLE 1
PHIP reactions and effects observed in ¹H spectra

| | Ethyl propiolate/ | Ethyl phenylpro- |
|---|---|---|
| Substrate/solvent | acetone | piolate/acetone |
| Reaction yield (%) | 0.82 | 0.23 |
| | (n = 10) | |
| Product concentration* | 1.75 ± 0.4 | 0.49 |
| (mM) | (n = 10) | (n = 4) |
| ALTADENA | 5,578 ± 2,824 | 1288 ^{a} |
| PHIP level (mM) | (n = 11) | |
| ALTADENA | 3,187 ± 1614 | 2653^{a} |
| enhancement factor | (n = 11) | |
| PASADENA | 1,975 ± 314 | 462 ^{a} |
| PHIP level (mM) | (n = 10) | |
| PASADENA | 1,129 ± 180 | 953^{a} |
| enhancement factor | (n = 10) | |

*per one hydrogenation step, i.e. injection of 5 ml of para-enriched hydrogen mixture at ambient pressure.
^{a}best result out of two studies.

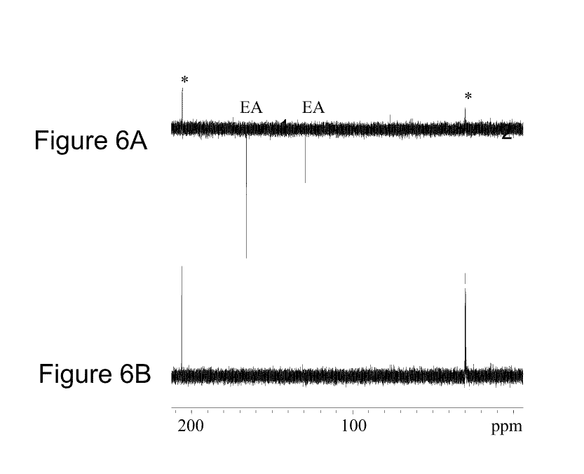

The results of a typical ¹³C-ALTADENA study are illustrated in FIG. 6. FIG. 6A demonstrates the hyperpolarized product signals which were recorded using one transient. The spectrum in FIG. 6B was recorded after the hyperpolarization decayed and after full alignment of the solvent signals with the main magnetic field (full intensity solvent signals). The averaged intensity of the hyperpolarized signal at 167 ppm was equivalent to 7,162±1,545 (n=4) mM and the enhancement factor was calculated to be 4,094±885 (n=4).

Hydrogenation of Ethyl Phenylpropiolate

The in situ hydrogenation of ethyl phenylpropiolate to ethyl cinnamate with the aid of a rhodium catalyst is described in FIG. 3, reaction IV. The ALTADENA and PASADENA PHIP spectra of this reaction are shown in FIGS. 9 and 10. The averaged product concentration and the reaction yield are summarized in Table 1. The maximal enhancement factors measured in these studies were ca. 2,700 and 1,000, respectively (Table 1).

Enhancement Factor and Polarization Level Considerations

Previous studies report on various orders of enhancement factors or polarization levels under varying experimental conditions. It is important to note that the enhancement factor and therefore the calculated polarization level depends critically on the combination of all of the experimental parameters such as the magnetic field strength used for recording the data, the temperature at which data were recorded, the duration from reaction to recording, the level of parahydrogen enrichment, and the PHIP type of experiment (ALTADENA or PASADENA). Also it is important to note whether the reported polarization levels are the measured ones or values obtained by extrapolation of the measured values taking into account the particular T₁ and the duration to recording. For this reason, evaluating the performance of our apparatus to previously published studies is not straightforward. Nevertheless a short review of the most relevant publications is given in the following:

For protons, after enrichment at 77 K, in an ALTADENA type of study: a polarization level of 0.3% (corresponding to ca. 670 enhancement factor) had been obtained at 1.5 T⁷; an enhancement factor of 300 was obtained in gas phase at 7 T, (corresponding to 0.6% polarization)⁸; and an enhancement factor of 12,000 (corresponding to 17.7% polarization) was obtained at 4.7 T⁵. At the same conditions, an enhancement factor of 1,800 was obtained in a PASADENA type of study⁵.

For carbon-13, using the PASADENA approach, a signal enhancement of 4,400⁹ (corresponding to 0.49% polarization) and a polarization level of −4%⁷, had been reported 1.5 T, and an enhancement factor of 37,400, corresponding to ca. 13% polarization was obtained at 4.7 T¹⁰. The latter represents an estimate of the initial polarization based on the measured enhancement factor, the duration to recording, and the product T₁. Using a hydrogen mixture that was more than 95% enriched with parahydrogen (at 14 K), the ¹³C signal enhancement at 7 T in an ALTADENA type of study was found to be −37,900, corresponding to a polarization of −21% (Jóhannesson 2004). An averaged 3,187 enhancement factor for protons in an ALTADENA study (Table 1) at 11.8 T was observed with the apparatus of the present invention, corresponding to 11.2% polarization. Taking into account the decay of the polarization during the transfer time (from the shield to the magnet, 15 s) and the T₁ of the vinylic protons (ca. 21 s), the initial polarization level is calculated to be ca. 23%. For ¹³C nucleus a 3.8% polarization was observed. Based on the literature described herein, the PHIP effects and the corresponding polarization levels obtained with the current apparatus (Table 1) appear to be on the higher end.

It is noted that the current studies were performed at 11.8 T where the polarization at thermal equilibrium is higher (linearly with the field) and therefore the expected enhancement factor is proportionally lower. The enhancement is commonly evaluated with respect to the thermal equilibrium state. However, the signal intensity obtainable from the thermal equilibrium state depends on the magnetic field strength (B₀) and the temperature (T) and is proportional to γB/kT where γ is the gyromeagnetic ratio and k is Boltzmann constant. Therefore, even though the p-H₂-derived polarization is field-independent, the enhancement factor does depend on the magnetic field in which the thermal equilibrium state is established^{5,8}.

In addition, it is noted that the data presented herewith correspond to actual enhancement factors and not to extrapolated enhancement factors because the actual enhancement factors provide the most relevant information for future bio-medical applications.

The PHIP Signals

The data summarized in Table 1 emphasize the various parameters that affect the PHIP signals. For example, the reaction yields: the reaction yield and the product concentration are about four folds higher in the reaction of ethyl propiolate, compared to ethyl phenylpropiolate. In agreement, the signal intensity for that reaction is four fold lower for both ALTADENA and PASADENA. However, it is noted that the reaction yield and the product concentration per se can not serve as sole predictive factors to the PHIP effect which is reaction dependent.

PHIP Signals from Other Products

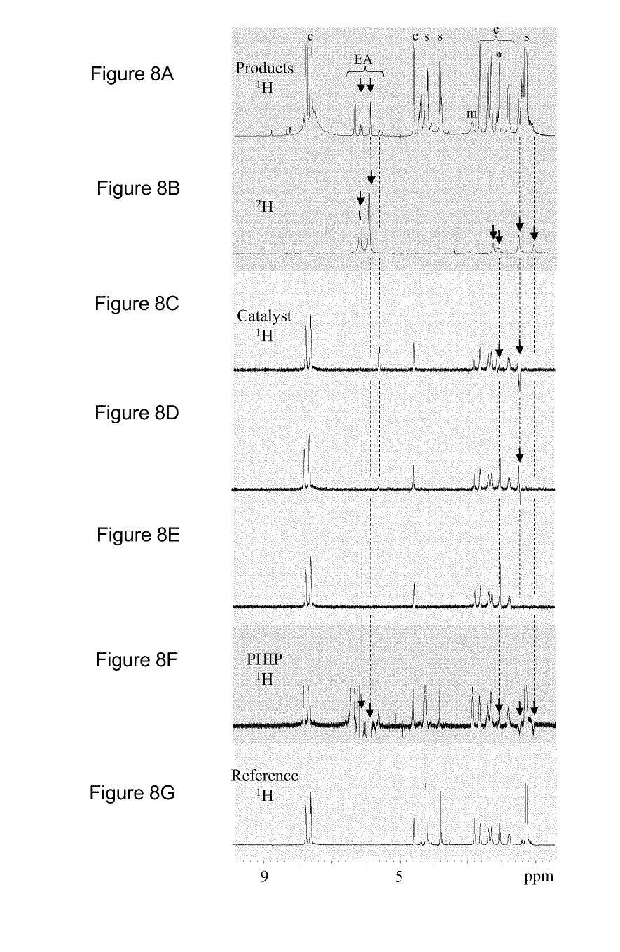

Interestingly, in all of the reactions described here, in addition to the expected vinyl PHIP signals, a PHIP signal has been continuously observed also at ca. 1.5 ppm. To reveal the source of this signal, a series of studies was carried out using the reaction of ethylpropiolate hydrogenation (FIG. 3, reaction III). This series is described in FIG. 8 which demonstrates the following: FIGS. 8A and 8B show the products of hydrogenation with normal hydrogen (H₂) and with deuterium (D₂), using ¹H and D spectra, respectively. The ²H spectrum of the hydrogenation with D₂ (FIG. 8B) demonstrates the signals from all of the hydrogenation products: the signals at 6.15 and 5.89 ppm (green arrows) were attributed to ethyl acrylate—the hydrogenation product of ethyl propiolate. The signals at ca. 2.25 ppm and at 1.05 ppm (blue arrows) were attributed to ethyl propionate, the product of the sequential hydrogenation of ethyl acrylate (FIG. 3, reaction IV), in agreement with a previous study⁵.

FIGS. 8C, 8D and 8E demonstrate the investigation of PHIP effects that are obtained by hydrogenation of the catalyst alone: the signal at 1.5 ppm (red arrow) in FIGS. 8C and 8D (ALTADENA and PASADENA, respectively) was attributed to hydrogenation of the COD ligand of the catalyst, because this chemical shift is in agreement with the chemical shift of cyclooctane, the product of the full COD hydrogenation (FIG. 3, reaction V). In addition, the ALTADENA spectrum of the catalyst hydrogenation (FIG. 9C) showed a PHIP signal at ca. 5.6 ppm attributed to cyclooctene¹³, the product of a single hydrogenation of the COD ligand. The signal at 2.1 ppm (orange arrow) in the ²H spectrum (FIG. 8B) was also attributed to hydrogenation of the catalyst and indeed, a small ALTADENA PHIP signal was observed when the catalyst alone was hydrogenated (FIG. 8C).

In the ALTADENA spectrum of the reaction with ethylpropiolate (FIG. 8F), the additional hyperpolarized signals at 1.5, 1.05 ppm are clearly visible as well as a small PHIP signal at 2.1 ppm.

1. A reactor for producing spin enriched hydrogen gas comprising:
a first compartment comprising at least two reagents capable of producing hydrogen gas;
a second compartment comprising at least one hydrogen spin converting catalyst; wherein at least a part of said second compartment containing said catalyst is maintained under temperatures enabling spin enriching of said hydrogen gas and at least another part of said second compartment is maintained at room temperature;
said first and second compartments being connected such that hydrogen gas produced in first compartment transfers into said second compartment; and
second compartment having an outlet for discharging spin enriched hydrogen gas produced.

2. A reactor according to claim 1, wherein said at least two reagents capable of producing hydrogen gas are selected from H₂O, D₂O, NaAlO₂ NaBH₄, NaBD₄, Al, Al/Na₂SnO₃ or any combinations thereof.

3. A reactor according to claim 1, wherein said at least one hydrogen spin converting catalyst is selected from iron oxide or activated carbon.

4. A reactor according to claim 1, wherein said temperatures enabling spin enriching of said hydrogen gas is provided using an external cooling chamber containing liquid nitrogen.

5. A reactor according to claim 1, wherein said connection of first and second compartments further comprises at least one drying tube.

6. A reactor according to claim 1, wherein said discharge outlet in second compartment is connected to a product receiving compartment.

7. A reactor according to claim 1, wherein said second compartment is made of transparent material.

8. A reactor according to claim 1, wherein said second compartment is made of low thermal conductivity material.

9. A method of producing spin enriched hydrogen gas comprising:
providing at least one first reagent capable of producing hydrogen gas in a first compartment;
reacting said at least one first reagent with at least one second reagent in first compartment to produce hydrogen gas;
transferring thus produced hydrogen gas to a second compartment comprising at least one hydrogen spin converting catalyst;
subjecting said second compartment to conditions for the production of spin enriched hydrogen gas.

10. A method according to claim 9, wherein said at least one first reagent capable of producing hydrogen gas is selected from NaAlO₂ NaBH₄, NaBD₄, Al, Al/Na₂SnO₃ or any combinations thereof.

11. A method according to claim 9, wherein said at least one second reagent is selected from H₂O, D₂O, HCl, DCl, NaOH, NaOD or any combinations thereof.

12. A method according to claim 9, wherein said at least one hydrogen spin converting catalyst is selected from iron oxide or activated carbon.

13. A method according to claim 9, wherein said conditions allowing the production of spin enriched hydrogen gas comprise subjecting at least a part of said second compartment comprising said at least one hydrogen spin converting catalyst to temperatures of between about 77 K to 17 K and maintaining at least another part of said second compartment to room temperature.

14. A method according to claim 9, wherein said conditions allowing the production of spin enriched hydrogen gas comprise subjecting at least a part of said second compartment comprising said at least one hydrogen spin converting catalyst to temperatures of between about 77 K to 17 K for about 10 min to about 5 h, and maintaining at least another part of said second compartment to room temperature at.

15. A method according to claim 9, wherein said produced hydrogen gas in said first compartment is dehydrated prior to transfer to second compartment.

16. A method according to claim 9, wherein said produced spin enriched hydrogen gas is dehydrated.
